(19) United States
(12) Patent Application Publication
(10) Pub. No.: US 2018/0372518 A1
(43) Pub. Date: Dec. 27, 2018

(54) METHOD FOR DETERMINING AT LEAST ONE VARIABLE OPERATIONAL CHARACTERISTIC OF A HYDRAULIC SYSTEM

(71) Applicant: ELBI INTERNATIONAL S.p.A., Torino (IT)

(72) Inventors: Paolo RAVEDATI, Moncalieri (Torino) (IT); Paolo DA PONT, Torino (IT)

(73) Assignee: ELBI INTERNATIONAL S.p.A., Torino (IT)

(21) Appl. No.: 15/781,882

(22) PCT Filed: Dec. 15, 2016
(86) PCT No.: PCT/IB2016/057639

§ 371 Date: Jun. 6, 2018

(30) Foreign Application Priority Data
Dec. 18, 2015 (IT) 102015000085326

(51) Int. Cl. G01F 1/115; G01F 1/12; G01F 1/36; G06K 19/06

(52) U.S. Cl. CPC G01F 1/115; G01F 1/125; G06K 19/06037; G06K 19/06028; G01F 1/363

(57) ABSTRACT

A method that allows the determination of at least one variable operational characteristic of a hydraulic system which includes a hydraulic fluid source a utilizing apparatus connected to the source through a conduit, and a flow-rate measuring device, positioned after the source for providing a signal indicative of the flow-rate of the liquid. The method includes the operations of providing in the hydraulic system an indicator device containing information indicative of the values taken by a predetermined parameter of the flow-rate measuring device as a function of the flow rate of the fluid; providing an acquisition means adapted to acquire the information from the indicator device; and predisposing an electronic processing means to calculate in a predetermined manner at least one operational characteristic of the hydraulic system, as a function of the flow-rate measuring device and of the information acquired by the indicator device.

### CROSS REFERENCE TO RELATED APPLICATIONS

This application is a National Stage of International Application No. PCT/IB2016/057639 filed Dec. 15, 2016, claiming priority based on Italian Patent Application No. 102015000085326 filed Dec. 18, 2015.

### BACKGROUND OF THE INVENTION

### Field of the Invention

The present invention regards a method for determining at least one variable operational characteristic of a hydraulic system.

More specifically, an object of the invention is a method for the determination of a variable operational characteristic of a hydraulic system which comprises
a hydraulic fluid source,
a utilizing apparatus connected with said source through a conduit for receiving a flow of said fluid, and
a flow-rate measuring device, positioned between the source and the utilizing apparatus for providing a signal indicative of the flow-rate of the liquid in said conduit, the flow-rate measuring device having at least one parameter which varies as a function of the flow-rate of the fluid flow.

### Background

Such a hydraulic system comprises for example a utilizing apparatus consisting of a washing machine, such as a clothes washing machine or a dishwasher, connected to a hydraulic fluid source or to the water distribution network, through a conduit to which is associated a controllable electric valve device, to selectively allow and prevent the flow of fluid, respectively, from the source towards the utilizing apparatus, and a flow-rate measuring device.

The flow-rate measuring device typically used in such a hydraulic system comprises a rotatable member, such as a turbine, exposed to the flow of hydraulic fluid which determines the rotation at a speed that is a function of the flow-rate of said fluid.

The rotatable member may be provided, for example, with one or more permanent magnets, integral in rotation with it, the passage of which is detected by at least one associated detector device, for example a Hall effect device, operationally stationary.

The detector then provides a pulsed electrical signal, the frequency of which is proportional to the rotation speed of the rotatable member and is therefore also a function of the flow-rate of the fluid flow.

With such a measuring device, the flow-rate of the fluid flow is determined by multiplying the number of revolutions (in a unit of time) of the rotatable member to a proportionality coefficient (k), which is a characteristic parameter for each specific measuring device.

For a flow-rate measuring device of this type, the value of the proportionality coefficient k varies very little over an extended field of values of the fluid flow-rate Q, in particular for higher flow-rate values of 1-2 l/minute, as shown in the exemplary graph reported in the appended FIG. 4. For lower values of the flow-rate Q, the proportionality coefficient k varies instead in a very pronounced way to vary the flow-rate Q, as is shown in the left part of the graph of FIG. 4.

For these flow-rate measuring devices, a nominal value kₙₒₘ of the proportionality coefficient is normally indicated in the specifications, corresponding to an average value of this coefficient in the field of flow-rate values wherein this coefficient varies very little or is substantially constant.

The use of such a nominal value of the proportionality coefficient k for the determination of the flow-rate is, however, a source of considerable error in the determination of the flow-rate, when the flow-rate has rather low values.

In a hydraulic system of the type described above, it would also be desirable to know with sufficient accuracy the value of the hydraulic fluid pressure provided by the source, which is typically a distribution network wherein the pressure of the fluid may also be subject to substantial variations.

An acceptably accurate determination of the dynamic pressure of the water supply of such a system is important, as it can affect appreciably the useful life of the flow-rate measuring device used, the electric valve device for controlling the flow between the source and the utilizing apparatus, as well as the service life of the utilizing apparatus itself.

Also the degree of filter clogging typically used at the entrance of such a utilizing apparatus depends, in its magnitude and in its rate of change, on the changes of the dynamic pressure of the hydraulic fluid delivered by the source.

An object of the present invention is therefore to propose a method which allows an accurate determination of at least one variable operational characteristic of a hydraulic system of the type defined above.

### SUMMARY OF THE INVENTION

This and other objects are achieved according to the invention with a method characterized in that it comprises the operations of
providing in said hydraulic system an indicator device containing information indicative of values of said at least one predetermined parameter of the flow-rate measuring device, as a function of the flow-rate of the fluid flow;
providing an acquisition means intended for acquiring said information from the indicator device; and
predisposing electronic processing means for calculating, according to predetermined ways, said at least one operational characteristic of the hydraulic system, as a function of the rate detected from the signal provided by the flow-rate measuring device and the information acquired from said indicator device.

The aforementioned variable characteristic of the hydraulic system may conveniently be the pressure P_{S} of the hydraulic fluid delivered from the source.

In the case of a flow-rate measuring device of the type described above, the aforementioned parameter is conveniently the proportionality coefficient k between the flow-rate Q of the fluid through the said measuring device and the number of revolutions n of the rotatable member of the measuring device in a unit of time. In the case of other flow-rate measuring devices, the aforementioned parameter is in general represented by another typical magnitude.

### BRIEF DESCRIPTION OF THE DRAWINGS

Further features and advantages of the invention will become apparent from the detailed description that follows, provided by way of non-limiting example with reference to the accompanying drawings, wherein:

FIG. 1 is a schematic representation of a hydraulic system wherein a method according to the present invention can be implemented;

FIGS. 2 and 3 are partial sectional, perspective and respectively side elevation views of an assembly including an electric valve device to control fluid flow in the hydraulic system of FIG. 1, provided with a flow-rate measuring device at its inlet for the implementation of the method according to the invention;

FIG. 4 (already described) is a graph showing an example of the trend of the proportionality coefficient k, reported on the y-axis, of a flow-rate measuring device, as a function of the flow-rate Q of the fluid flow, reported on the x-axis;

FIG. 5 is a block diagram that illustrates the devices used for the implementation of the method according to the invention; and

FIG. 6 is an illustrative flow diagram of the method according to the invention.

### DETAILED DESCRIPTION OF THE INVENTION

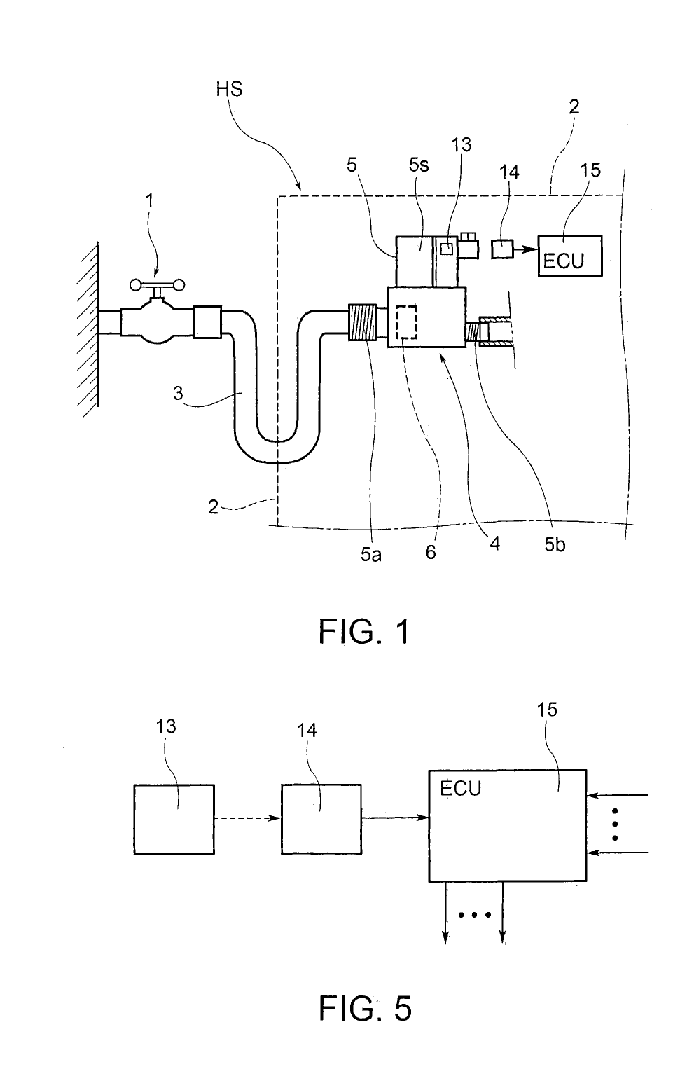

FIG. 1 shows a hydraulic system, indicated collectively at HS, wherein the method according to the present invention is appropriately feasible.

The hydraulic system HS in the illustrated embodiment comprises a hydraulic fluid source 1, such as a supply tap connected to a water distribution network.

The HS system further comprises a utilizing apparatus, indicated collectively at 2, such as a washing machine (clothes washing machine or dishwasher).

The utilizing apparatus 2 is connected to the source 1 by a conduit 3 to receive a flow of water from this source.

In the exemplary embodiment illustrated, in the utilizing apparatus 2, the conduit 3 belongs to a unit indicated collectively at 4, which, as will appear more clearly from the following description, includes an electric valve device 5, to which a flow-rate measuring device 6 is associated.

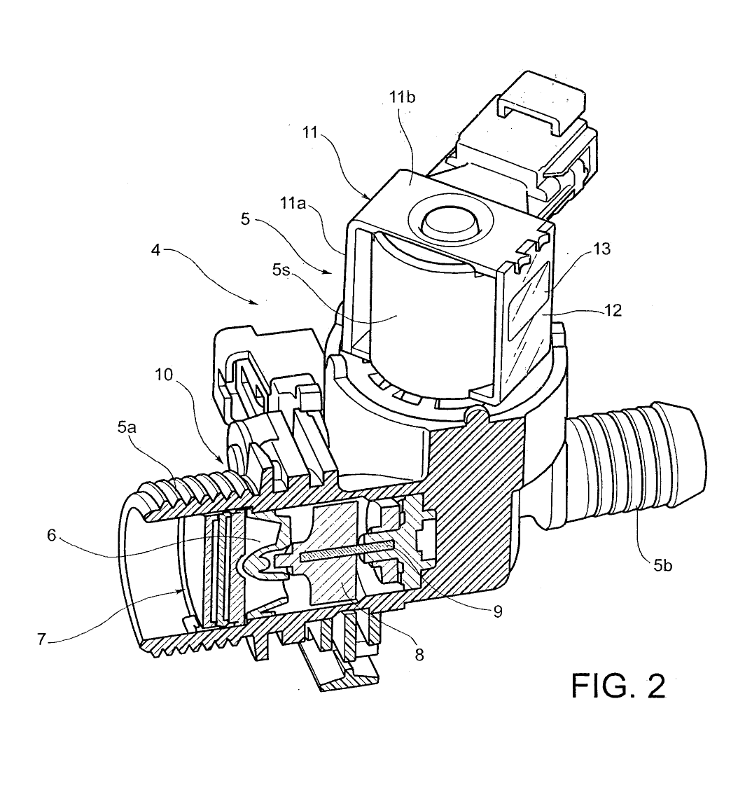

In the embodiment which will be described hereinafter with reference to FIGS. 2 and 3, the flow-rate measuring device 6 is positioned in the same body as the electric valve device 5, in particular in its inlet fitting 5a, downstream of the filters 7. This solution is however not strictly required: in alternative embodiments, the flow-rate measuring device may be positioned at the outlet of the electric valve device 5. Also, in general, the flow-rate measuring device may be built as a component in its own right connected to the electric valve 5 or to the conduit 3 in a manner known per se.

The electric valve device 5 is also of a type known per se and has an outlet fitting 5b for the hydraulic flow that is controlled, i.e. allowed or prevented, by means of a control solenoid 5s that controls the position of a movable plunger with respect to an associated valve seat.

In the illustrated embodiment, the flow-rate measuring device 6 comprises a member 8 provided with blades, in the manner of a turbine, rotatably mounted on a pin 9 inside the inlet fitting 5a of the electric valve 5.

In manner known per se, the rotatable member 8 is provided with at least one permanent magnet in a radially peripheral position.

The flow-rate measuring device further comprises a detecting device 10 (FIG. 2) intended to detect passages on it of said at least one permanent magnet and providing signals indicative of the frequency of these passages, and therefore the rotation speed of the rotatable member 8. Ultimately, the detector device 10 provides output signals indicative of the flow-rate of the fluid flow which operationally moves from the source 1 to the utilizing apparatus 2 through the conduit 3 and the unit 4, including the electric valve device 5 and the flow-rate measuring device 6.

In the exemplarily illustrated embodiment, the electric valve device 5 has a magnetic circuit for closing the magnetic flux generated in operation by the solenoid 8. Such a magnetic circuit comprises in particular an element 11 in the shape of an inverted L with a vertical branch 11a and an upper horizontal branch 11b. The distal end of the latter is connected to a vertical plate-like element 12.

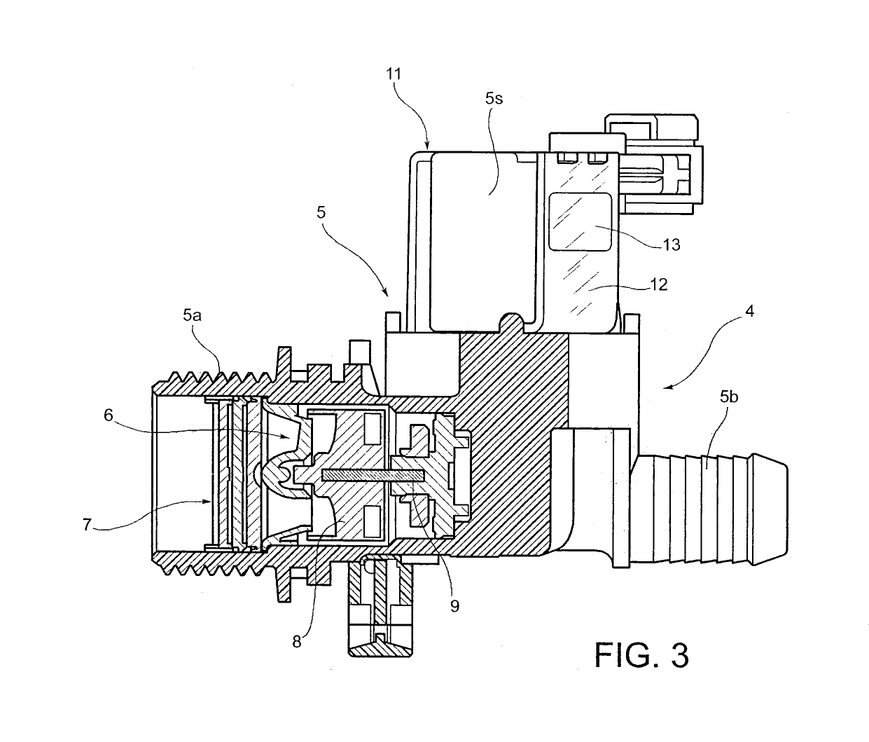

In the illustrated embodiment, an indicator device 13 is fixed to the plate-like element 12 of the magnetic circuit of the electric valve device. This device bears or contains information or data indicative of the values taken by the coefficient k of the flow-rate measuring device, as a function of the flow-rate Q of the fluid flow. This information or data may correspond to the values of k and Q corresponding to the circles in the graph in FIG. 4.

In a flow-rate measuring device having the characteristic illustrated in FIG. 4, a nominal value kₙₒₘ of the coefficient k equal to, for example, 237, or equal to the average value that the coefficient k taken in the field of flow-rate Q values between 1-2 l/minute and 10 l/minute inclusive.

The indicator device 13 may be an electronic memory chip or an RFID tag, or even a simple bar code or QR code.

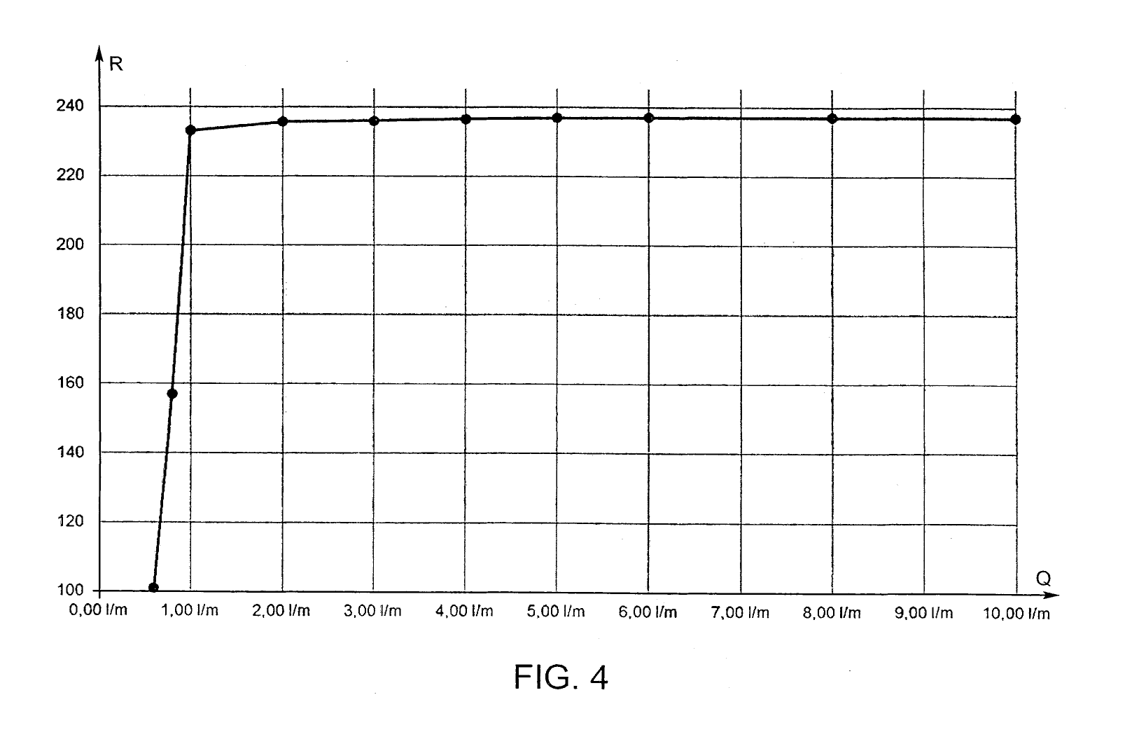

For the implementation of a method according to the present invention, a capture device is provided, such as the one schematically represented and indicated at 14 in FIG. 5, to acquire from the indicator device 13 the information contained in it.

The capture device may be a barcode or QR code reader, or an RFID reader.

The capture device 14 is connected to an electronic processing and control unit, indicated at 15 in FIG. 5. This unit may be a control unit inside the utilizing apparatus 2, for example, the electronic control unit of the operation of the same utilizing apparatus 2.

Alternatively, the capture device 14 and the associated electronic unit 15 may also simply be part of a device separate from the utilizing apparatus, for example, a data acquisition and diagnosis device.

In any case, the electronic unit 15 is provided to calculate, according to a predetermined manner, at least one characteristic of the hydraulic operation system HS and this in function of the detected speed of the rotatable member 8 of the flow-rate measuring device 6 and the information that this unit 15 has acquired from the indicating device 13.

In particular, as will be seen later, the electronic unit 15 is provided to calculate values of the fluid flow-rate between the source 1 and the utilizing apparatus 2 according to a predetermined manner as a function of the speed detected by the rotatable member 8 of the flow-rate measuring device 6 and the coefficient k values, possibly stored as a table or vector, or the like.

The aforementioned at least one variable characteristic of the hydraulic system HS may simply be an accurate value of the flow-rate of the fluid flow through the HS system and/or the dynamic pressure of the hydraulic fluid delivered from the source.

For this purpose, the electronic unit 15 is appropriately provided for:
calculating a nominal value Qₙₒₘ of the flow-rate of the fluid flow between the source 1 and the utilizing apparatus 2, substantially by multiplying the detected number of revolutions n of the rotatable member 8 of the flow-rate measuring device 6 by the nominal value kₙₒₘ of said proportionality coefficient (k) of the flow-rate measuring device:

Qₙₒₘ=kₙₒₘ·n;
determining an updated, more accurate, value k_{acc} of said proportionality coefficient k of the flow-rate measuring device which, on the basis of information carried by the indicator device 13, is associated to the calculated nominal value Qₙₒₘ of the flow-rate Q of the fluid flow:

k_{acc}=f(Qₙₒₘ)

where f indicates the functional link that correlates the proportionality coefficient k with the flow-rate Q, according to the graph of FIG. 4 associated with the flow-rate measuring device 6;
calculating therefore an updated, more accurate, value Q_{acc} of the flow-rate Q of said fluid flow, substantially by multiplying the updated value k_{acc} of said proportionality coefficient k by the detected number of revolutions of said rotatable member 8 of the flow-rate measuring device 6:

Q_{acc}=k_{acc}·n.

The Q_{acc} value is therefore far more accurate than the Qₙₒₘ value that would otherwise be assumed by simply using the nominal value kₙₒₘ of the proportionality coefficient k of the flow-rate measuring device.

The most accurate determination of the flow-rate of the fluid flow then enables an accurate calculation of the volume of liquid which at a given time t passes through the hydraulic system HS and is fed to the utilizing apparatus 2:

Vol=Q_{acc}·t.

The determination of an accurate value of volume Vol allows an easy determination of the pressure Pₛ of the hydraulic fluid delivered from the source:

Pₛ=g(Vol).

The functional link g between the volume Vol and the supply pressure Pₛ is determined based on the hydraulic geometric characteristics of the HS system components.

The determination of the value of the supply pressure P_{S} of the fluid, or the fluid pressure which reaches the electric valve device 5, allows one to derive a plurality of useful information on the remaining life of the electric valve device 5 and the flow-rate measuring device 6, the degree of clogging of the inlet filters 7 of the solenoid 5 and the possible need to have them cleaned.

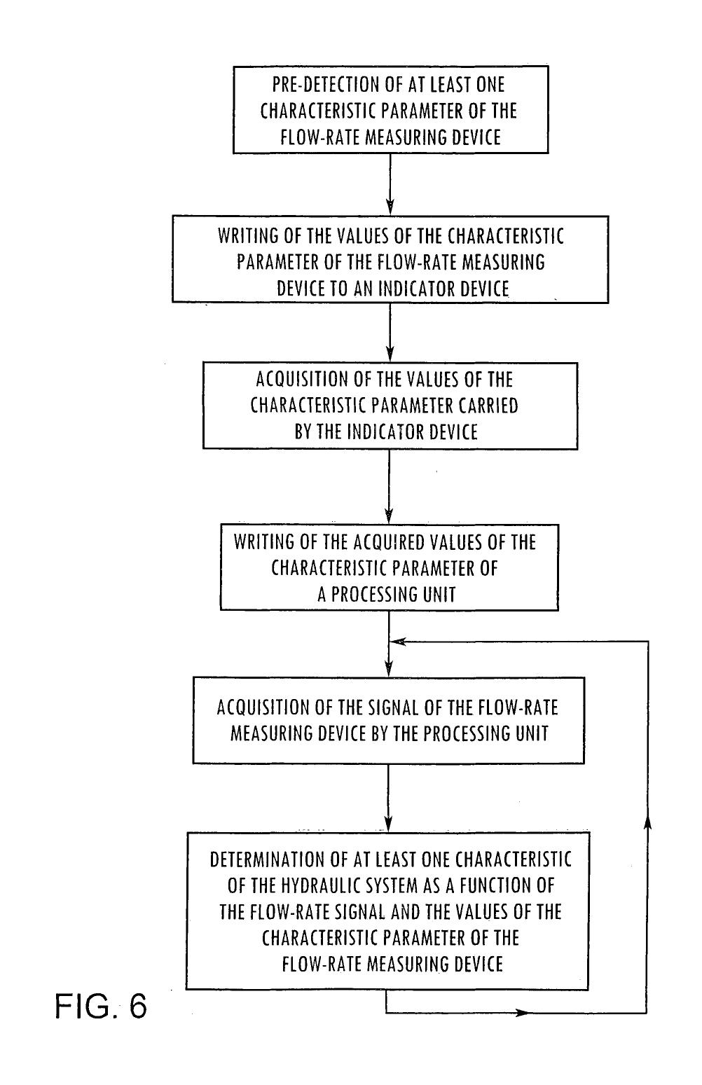

The method according to the present invention is briefly illustrated in FIG. 6 in the form of a flow chart, which forms an integral part of the present invention.

The information on the remaining useful life of the electric valve and the flow-rate measuring device may also be useful for the performance of periodic service assistance.

The method according to the present invention therefore has obvious advantages.

Naturally, without altering the principle of the invention, the embodiments and the details of construction may vary widely with respect to those described and illustrated purely by way of non-limiting example, without thereby departing from the scope of the invention as defined in the appended claims.

The invention is also particularly applicable when the flow-rate measuring device used is different from that considered in the exemplary embodiment described herein and illustrated, for example, in the case of using differential pressure, ultrasonic or fluid-dynamic measuring devices.

1. A method for determining at least one variable operational characteristic (Q_{acc}; Vol, P_{S}) of a hydraulic system (HS) which comprises
a hydraulic fluid source (1),
a utilizing apparatus (2) connected with said source (1) through a conduit (3) for receiving a flow of said fluid, and
a flow-rate measuring device (6), arranged between the source (1) and the utilizing apparatus (2) for providing a signal indicative of the flow-rate of the liquid in said conduit; the flow-rate measuring device (6) having at least one parameter (k) which varies as a function of the flow-rate of the fluid;
the method being characterized by comprising the steps of:
providing in said hydraulic system (HS) an indicator device (13) containing information indicative of values of said at least one predetermined parameter (k) of the flow-rate measuring device (6), as a function of the flow-rate (Q) of the fluid flow;
providing acquisition means (14) adapted for acquiring said information from said indicator device (13); and
predisposing electronic processing means (15) for calculating in predetermined manners said at least one operational characteristic (Q_{acc}; Vol; Pₛ) of the hydraulic system (HS), as a function of the signal provided by the flow-rate measuring device (6) and the information acquired from said indicator device (13).

2. A method according to claim 1, wherein said at least one variable characteristic of the hydraulic system (HS) is the pressure (P_{S}) or the flow-rate (Q_{acc}) of the hydraulic fluid delivered by said source (1).

3. A method according to claim 1, wherein use is made of a flow-rate measuring device (6) of the turbine type, including a rotatable member (8) operatively exposed to said liquid flow, and detector means (10) adapted for providing electric signals indicative of the rotational speed of said rotatable member (8).

4. A method according to claim 3, wherein said parameter of the flow-rate measuring device (6) is the proportionality coefficient (k) between the flow-rate (Q) of the fluid flow which passes through said measuring device (6) and the number of revolutions (n) of the rotatable member (8) of said measuring device (6) per time unit.

5. A method according to claim 4, wherein the electronic processing means (15) are predisposed for computing values (Qₙₒₘ; Q_{acc}) the flow-rate of the fluid flow between the source (1) and the utilizing apparatus (2) in predetermined manners as a function of the detected number of revolutions (n) of said rotatable member (8) of the flow-rate measuring device and of values of said proportionality coefficient (k), possibly stored in form of tables or equivalents.

6. A method according to claim 4, wherein the electronic processing means (15) are predisposed for
calculating a nominal value (Qₙₒₘ) of the fluid flow-rate between the source (1) and the utilizing apparatus (2), substantially by multiplying the detected number of revolutions (n) of the rotatable member (8) of the flow-rate measuring device (6) by a nominal value (kₙₒₘ) of said proportionality coefficient (k);
determining an updated value (k_{acc}) of said proportionality coefficient (k) which, on the basis of information carried by the indicator device (13), corresponds to the calculated nominal value (Qₙₒₘ) of the flow-rate (Q) of the fluid flow; and
calculating an updated value (Q_{acc}) of the flow-rate (Q) of said fluid flow, substantially by multiplying the updated value (k_{acc}) of said proportionality coefficient (k) by the detected number of revolutions (n) of said rotatable member (8).

7. A method according to claim 1, to be carried out in a hydraulic system (HS) comprising further an electric valve device (5) adapted to be driven such as to selectively allow and prevent said fluid flow, respectively, between the source (1) and the utilizing apparatus (2), wherein said electronic processing means (15) are further predisposed for detecting an opening time (t) of said electric valve device (5) and calculating the volume (Vol) of said fluid delivered to the utilizing apparatus (2) during said opening time (t).

8. A method according to claim 2, wherein the electronic processing means (15) are predisposed for computing said volume of fluid (Vol) as a function of a detected opening time (t) of the electric valve device (5) and of the updated value (Q_{acc}) of the flow-rate (Q) of said fluid flow.

9. A method according to claim 7, wherein said electronic processing means (15) are predisposed for calculating the pressure (P_{S}) of the hydraulic fluid delivered by the source (1), as a function of the calculated value of said volume of fluid (Vol).

10. A method according to claim 1, wherein said indicator device (13) comprises a memory microchip, or an RFID tag, or a bar code or a QR code.

11. A method according to claim 10, wherein said indicator device (13) is applied on the outside of said flow-rate measuring device (6) or to the electric valve device (5).

12. A flow-rate measuring device (6) for use in a method according to claim 1, characterized in that it is provided on its outside with said indicator device (13).

13. An electric valve device (5) for use in a method according to claim 7, characterized in that it is provided on its outside with said indicator device (13).

14. A utilizing apparatus (2) for use in a hydraulic system (HS) for allowing the performance of a method according to claim 1, characterized in that it is provided with said indicator device (13).
